(19) United States
(12) Patent Application Publication
(10) Pub. No.: US 2014/0321818 A1
(43) Pub. Date: Oct. 30, 2014

(54) ELECTRONIC DEVICE WITH CABLE

(71) Applicant: SUMITOMO ELECTRIC INDUSTRIES, LTD., Osaka-shi, Osaka (JP)

(72) Inventors: Hajime Arao, Yokohama-shi (JP); Toshihisa Yokochi, Yokohama-shi (JP)

(21) Appl. No.: 14/360,968

(22) PCT Filed: Oct. 17, 2013
(86) PCT No.: PCT/JP2013/078123

§ 371 Date: May 28, 2014

(30) Foreign Application Priority Data
Nov. 6, 2012 (JP) 2012-244830

(51) Int. Cl. G02B 6/42

(52) U.S. Cl. CPC G02B 6/4246; G02B 6/4231; G02B 6/4268
USPC 385/89

(57) ABSTRACT

An electronic device with cable includes a circuit substrate, an electrical connector that is connected to one end of the circuit substrate, a cable that is connected to the other end of the circuit substrate, a metal housing that accommodates the electrical connector and the circuit substrate, a first resin housing that engages with the metal housing so as to cover at least a portion of the metal housing, and a second resin housing that engages with the metal housing so as to cover at least another portion of the metal housing.

### TECHNICAL FIELD

The present invention relates to an electronic device with cable.

### BACKGROUND OF THE INVENTION

Patent Literature 1 discloses a photoelectric conversion module in which a protection cover is formed by molding a resin on the outer side of a metal case accommodating an electrical connector and a circuit substrate.

### CITATION LIST

### Patent Literature

[PTL 1] JP-A-2010-10254

### SUMMARY OF INVENTION

In Patent Literature 1, a load is applied to the metal case when a resin is molded on the outer side of the metal case, and thus there is a possibility of the electrical connector and the substrate, which are accommodated in the metal case, being adversely affected. In addition, there is a possibility of the resin, constituting the protection cover flowing into the metal case and coming into contact with the substrate at the time of the molding, and thus special consideration for eliminating a gap in the metal case is necessary.

In this case, a method of covering the metal case with a resin case constituted by a resin molded product is considered. However, when the resin case is mounted onto the metal case in a state where a cable such as a photoelectric composite wire is connected to the substrate, it is difficult to regulate the movement of the resin case in a front-back direction. One aspect of the present invention has been made in view of such problem.

In order to achieve the above-described object, an electronic device with cable of the invention, comprises:

a circuit substrate;

an electrical component mounted on the circuit substrate;

an electrical connector connected to one end of the circuit substrate;

a cable connected to the other end of the circuit substrate;

a metal housing which accommodates the electrical connector and the circuit substrate;

a first resin housing which engages with the metal housing so as to cover at least a portion of an outer surface of the metal housing; and

a second resin housing which engages with the metal housing so as to cover at least another portion of the outer surface of the metal housing.

### BRIEF DESCRIPTION OF DRAWINGS

FIG. 1 is a perspective view showing an optical module according to this embodiment.

FIG. 2A is a perspective view showing a first resin housing of the optical module shown in FIG. 1.

FIG. 2B is a cross-sectional view showing the first resin housing of the optical module shown in FIG. 1.

FIG. 3A is a perspective view showing a second resin housing of the optical module shown in FIG. 1.

FIG. 3B is a cross-sectional view showing the second resin housing of the optical module shown in FIG. 1.

FIG. 4 is a perspective view showing a metal housing of the optical module shown in FIG. 1.

FIG. 5 is a perspective view showing a circuit substrate and a cable which are accommodated in the metal housing shown in FIG. 4.

FIG. 6A is a top view of the circuit substrate shown in FIG. 5.

FIG. 6B is a side view of the circuit substrate shown in FIG. 5.

FIG. 7 is a cross-sectional view of the optical module shown in FIG. 1.

FIG. 8 is a partially enlarged transverse cross-sectional view showing an engaged state of the first resin housing and the metal housing.

FIG. 9 is a partially enlarged vertical cross-sectional view showing an engaged state of the second resin housing and the metal housing.

### DESCRIPTION OF EMBODIMENTS

First, one embodiment of an electronic device with cable according to one aspect of the present invention will be described.

An electronic device with cable of the embodiment, includes:

a circuit substrate on which an electrical component is mounted;

an electrical connector connected to one end of the circuit substrate;

a cable connected to the other end of the circuit substrate;

a metal housing which accommodates the electrical connector and the circuit substrate;

a first resin housing which engages with the metal housing so as to cover at least a portion of the metal housing; and

a second resin housing which engages with the metal housing so as to cover at least another portion of the metal housing.

wherein the metal housing has a first engagement portion engaging with the first resin housing and a second engagement portion engaging with the second resin housing, and

wherein movement of the first resin housing to the cable side is regulated by the first engagement portion, and movement of the second resin housing to the electrical connector side is regulated by the second engagement portion.

In the electronic device with cable of the embodiment, at least one of the first engagement portion and the second engagement portion may engage with a step portion which is provided on the inner side of at least one of the first resin housing and the second resin housing.

In the electronic device with cable of the embodiment, the first engagement portion may engage with an opening portion, provided in a tube portion of the first resin housing, or the step portion, the second engagement portion may engage with the step portion, provided on the inner side of the second resin housing, or the opening portion, and the first resin housing and the second resin housing may be fitted to each other so as to cover the opening portion provided in the one of the first resin housing and the second resin housing with the other one of the first resin housing and the second resin housing.

Further, in the electronic device with cable of the embodiment, the second engagement portion may be provided in a surface different from a surface in which the first engagement portion is provided in the metal housing.

Further, in the electronic device with cable of the embodiment, the metal housing may be provided with a regulation portion that regulates movement of the second resin housing to the cable side.

Further, in the electronic device with cable of the embodiment, the circuit substrate may be connected to the metal housing through a supporting member with heat conduction performance.

According to the embodiment, it is possible to assemble without applying a load to a component accommodated in a metal housing and to appropriately regulate the movement of a resin housing after the assembly.

An optical module 1 (example of electronic device with cable) according to an embodiment of the present invention is used for signal (data) transmission in optical communication technology and the like. The optical module 1, which is electrically connected to an electronic device such as a personal computer, converts an input/output electrical signal into an optical signal and transmits the optical signal.

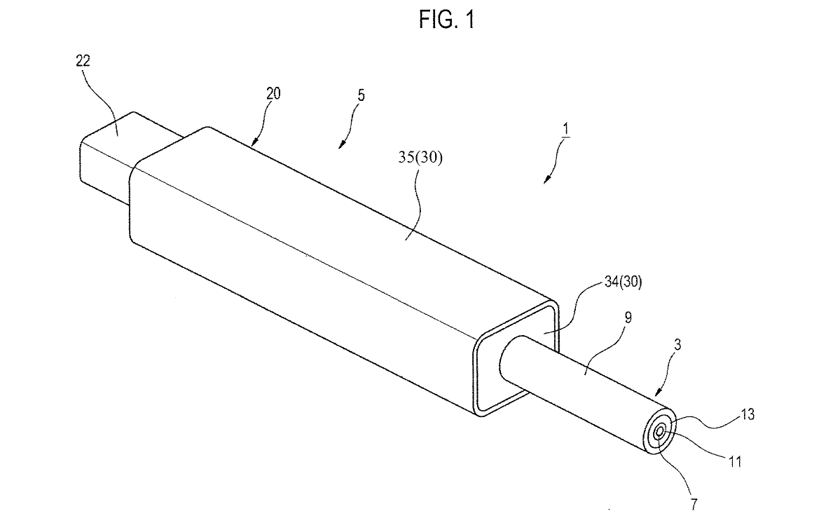

As shown in FIG. 1, the optical module 1 includes an optical cable 3 and a connector module 5. The optical module 1 is configured such that a terminal of the single-fiber or multi-fiber optical cable 3 is attached to the connector module 5.

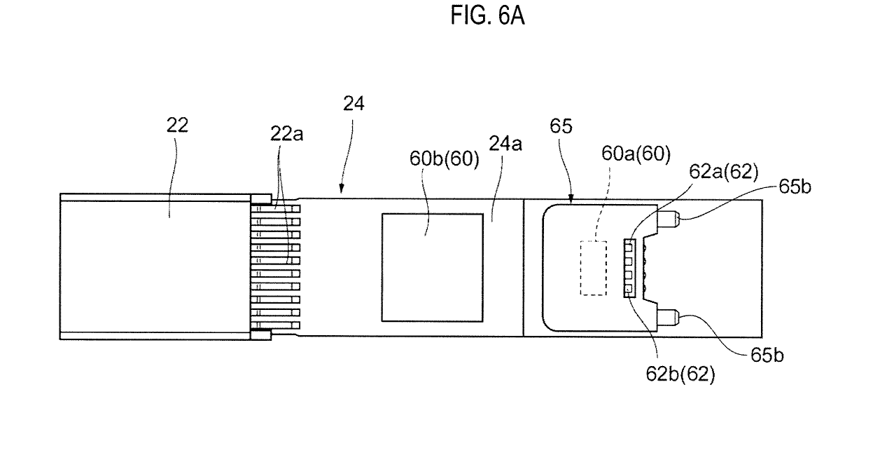

As shown in FIG. 1 and FIG. 6, the optical cable 3 includes a plurality of coated optical fibers 7, a jacket 9 that is formed of a resin and covers the coated optical fibers 7, tensile strength fibers (Kevlar (registered trademark)) 11 which are interposed between the coated optical fibers 7 and the jacket 9 and have an ultrafine diameter, and a metal braid (metal layer) 13 that is interposed between the jacket 9 and the tensile strength fibers 11. In other words, in the optical cable 3, the coated optical fibers 7, the tensile strength fibers 11, the metal braid 13, and the jacket 9 are disposed in this order toward the outside in the radial direction from the center thereof.

An optical fiber in which a core and a cladding are quartz glass (AGF: All Glass Fiber), an optical fiber in which a cladding is formed of rigid plastic (HPCF: Hard Plastic Clad Fiber), or the like can be used as the coated optical fiber 7. The jacket 9 is formed of, for example, PVC (polyvinylchloride) which is a non-halogen fire-retardant resin. The tensile strength fiber 11 is, for example, an aramid fiber, and is embedded in the optical cable 3 in a state where the tensile strength fibers are gathered in the form of a bundle.

The metal braid 13 is formed of, for example, a tinned electrically-conductive wire. The metal braid 13 is configured as a heat conduction member having a higher thermal conductivity than a metal housing 40 to be described later. The thermal conductivity is, for example, 400 W/m·K. It is preferable that the metal braid 13 be disposed at a high density in order to satisfactorily secure heat conduction, and as an example, it is preferable that the metal braid be formed of a tinned electrically-conductive wire which is a rectangular wire.

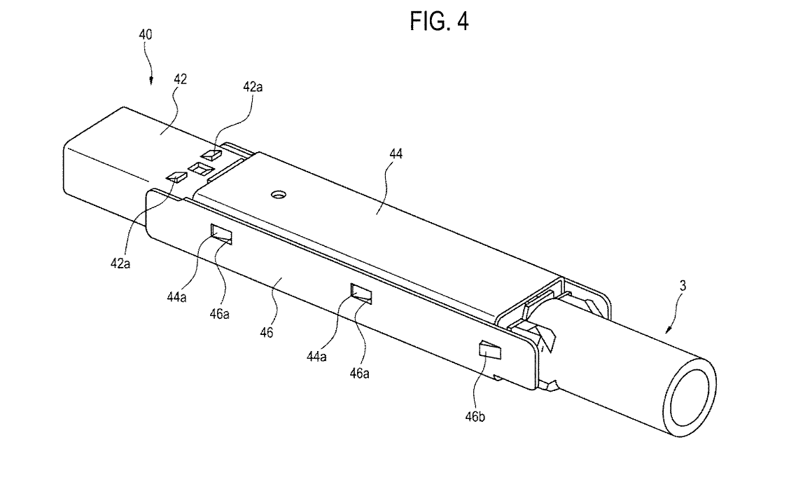

The connector module 5 includes a housing 20, an electrical connector 22 provided on the front end (tip) side of the housing 20, and a circuit substrate 24 accommodated in the housing 20. The housing 20 is constituted by a resin housing 30 and a metal housing 40 (see FIG. 4) that is disposed within the resin housing 30.

The resin housing 30 includes a first resin housing 32 and a second resin housing 35. The first resin housing 32 and the second resin housing 35 are formed of, for example, a resin material such as polycarbonate.

Meanwhile, a configuration may be adopted in which a boot, not shown in the drawing, which covers the optical cable 3 is provided on the side further toward the rear end of the first resin housing.

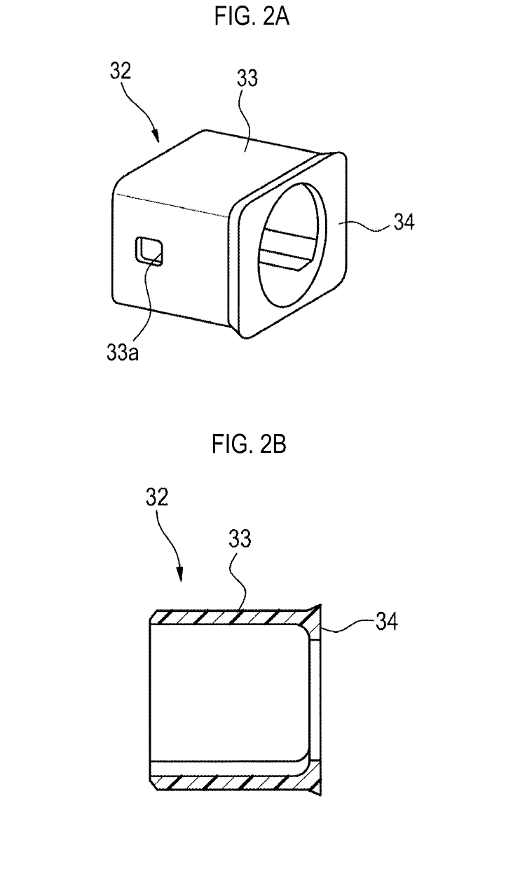

The first resin housing 32, which is a member disposed on the rear end side of the metal housing 40, includes a tube portion 33 and an outer surface portion 34 which are provided at the rear end of the tube portion 33, as shown in FIGS. 2A and 2B. The tube portion 33 covers fixation portions of the metal housing 40 and the optical cable 3. The outer surface portion 34 is bonded to the jacket 9 of the optical cable 3, using an adhesive (not shown). The tube portion 33 is provided with an opening portion 33a in both lateral sides thereof.

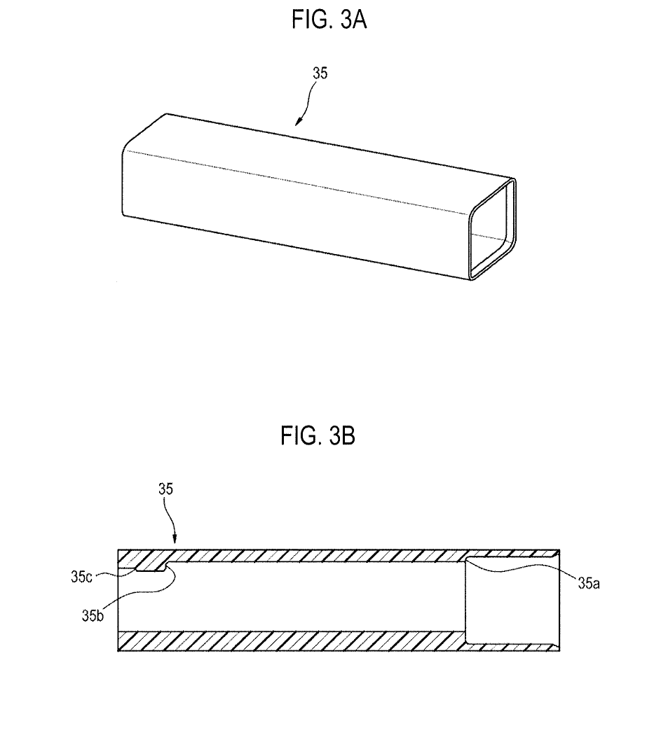

As shown in FIGS. 3A and 3B, the second resin housing 35 is disposed so as to cover a portion of the outer surface of the metal housing 40 and the entire tube portion 33 of the first resin housing 32. An inner wall surface of the second resin housing 35 is provided with a first step portion 35a, a second step portion 35b, and a third step portion 35c.

The first step portion 35a, which is the rear end side of the second resin housing 35, is provided across the entire region of the inner wall surface of the second resin housing 35 in a cross-section perpendicular to the longitudinal direction thereof. This first step portion is a step that abuts against a front end surface of the tube portion 33 when the tube portion 33 of the first resin housing 32 is covered with the second resin housing 35 to regulate the movement of the tube portion 33.

The second step portion 35b, which is the front end side of the second resin housing 35, is provided in an upper surface of the inner wall surface of the second resin housing 35 in a cross-section perpendicular to the longitudinal direction thereof. The second step portion 35b is a step that abuts against a front end portion (an example of a regulation portion) of the second metal housing 44 when the metal housing 40 to be described later is covered with the second resin housing 35 to regulate the movement of the second resin housing 35 to the optical cable 3 side which is the rear end side of the second resin housing 35.

The third step portion 35c, which is an end side further forward than the second step portion 35b of the second resin housing 35, is provided in the upper surface of the inner wall surface of the second resin housing 35 in a cross-section perpendicular to the longitudinal direction thereof. The third step portion 35c is a step that abuts against an engagement portion 42a of a first metal housing 42 to be described later when the metal housing 40 to be described later is covered with the second resin housing 35 to fix the second resin housing 35 and the first metal housing 42.

As shown in FIG. 4, the metal housing 40 is constituted by a first metal housing 42, a second metal housing 44, and a third metal housing 46. The metal housings 42, 44, and 46 are formed of a metal material such as steel (Fe-based), a tin plate (tinned copper), stainless steel, copper, brass, or aluminum, which has a high thermal conductivity (preferably equal to or greater than 100 W/m·K), and constitute a thermal conductor.

The first metal housing 42 is a member that accommodates the circuit substrate 24 therein. An electrical connector 22 is accommodated in the front end side of the first metal housing 42. The optical cable 3 is connected to the rear end side of the first metal housing 42 through a connection portion 15 formed of a metal plate. In an upper surface of the first metal housing 42, the engagement portion 42a (an example of a second engagement portion) which engages with the third step portion 35c is provided at a location corresponding to the second step portion 35b of the third step portion 35c.

The second metal housing 44 is a member that has a substantially U-shaped cross-section and is opened downwards. Both lateral sides of the second metal housing 44 are provided with a convex portion 44a that engages with a concave portion 46a provided in a third metal housing 46 to be described later.

The third metal housing 46 is a member that has a substantially U-shaped cross-section and is opened upwards. Both lateral sides of the third metal housing 46 are provided with the concave portion 46a that engages with the convex portion 44a of the second metal housing 44, and an engagement portion 46b (an example of a first engagement portion) which engages with the opening portion 33a is provided at a location corresponding to the opening portion 33a provided in both the lateral sides of the tube portion 33 of the first resin housing 32.

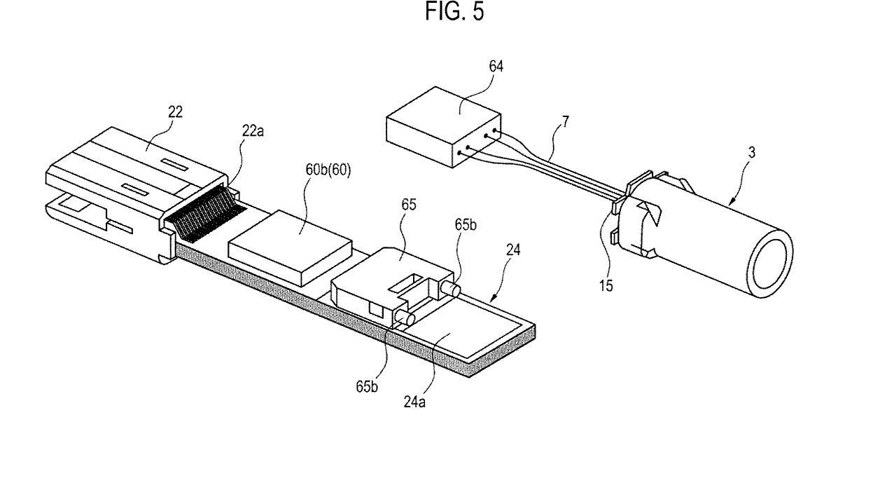

The electrical connector 22 is a portion inserted into a connection target (personal computer, etc.) and electrically connected to the connection target. As shown in FIG. 1, the electrical connector 22 is disposed on the front end side of the housing 20, and protrudes forward from the resin housing 30. As shown in FIG. 5, the electrical connector 22 is electrically connected to the circuit substrate 24 by a contactor 22a.

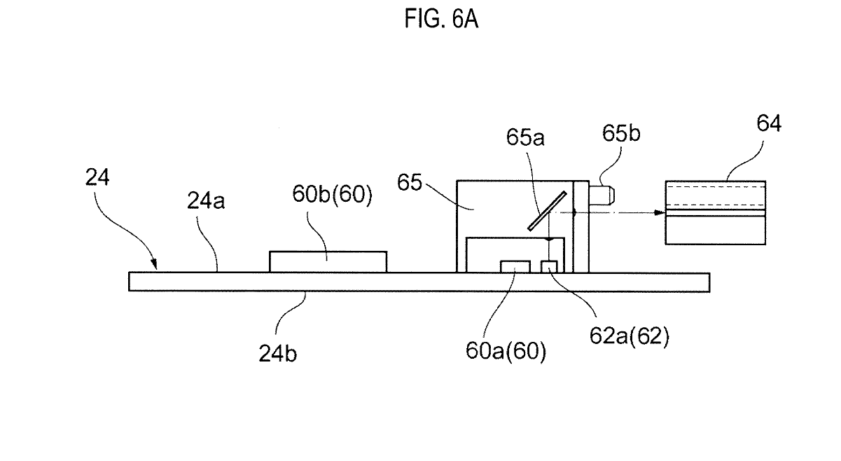

The circuit substrate 24 is a member accommodated in the accommodation space S (See FIG. 7) of the metal housing 40. As shown in FIG. 5 and FIGS. 6A and 6B, a control semiconductor 60 and a light receiving and emitting element 62 (example of electrical component) are mounted on the circuit substrate 24. The circuit substrate 24 electrically connects the control semiconductor 60 and the light receiving and emitting element 62. For example, the circuit substrate 24 is an insulated substrate such as a glass epoxy substrate or a ceramic substrate, and a circuit wiring formed of, for example, gold (Au), aluminum (Al), or copper (Cu) is formed in the surface of the circuit substrate or inside the circuit substrate. The control semiconductor 60 and the light receiving and emitting element 62 constitute a photoelectric conversion unit.

The control semiconductor 60 includes, for example, a driving integrated circuit (IC) 60a and a clock data recovery (CDR) device 60b which is a waveform shaper. The control semiconductor 60 is disposed on the front end side of a surface 24a in the circuit substrate 24 and is electrically connected to the electrical connector 22.

The light receiving and emitting element 62 is disposed on the back end side of the surface 24a in the circuit substrate 24, and includes a plurality of light emitting elements 62a and a plurality of light receiving elements 62b. For example, a light emitting diode (LED), a laser diode (LD), or a vertical cavity surface emitting laser (VCSEL) can be used as the light emitting element 62a. For example, a photodiode (PD) can be used as the light receiving element 62b.

The light receiving and emitting element 62 is optically connected to the coated optical fibers 7 of the optical cable 3. Specifically, as shown in FIG. 5B, a lens array component 65 is disposed in the circuit substrate 24 so as to cover the light receiving and emitting element 62 and the driving IC 60a. The lens array component 65 is provided with a reflection film 65a that reflects and bends light emitted from the light emitting element 62a or light emitted from the coated optical fibers 7. A connector component 64 is attached to a terminal of the coated optical fiber 7 that is extracted from the optical cable 3. The connector component 64 and the lens array component 65 are positioned using a positioning pin 65b of the lens array component 65 to be coupled to each other, and thus the coated optical fibers 7 and the light receiving and emitting element 62 are optically connected to each other. The lens array component 65 can be integrally configured by injection molding using a resin.

As shown in FIG. 7, a first heat conducting sheet 70 is disposed in the accommodation space S. The first heat conducting sheet 70 is as supporting member as a thermal conductor that is formed of a material with thermal conductivity and flexibility. The first heat conducting sheet 70 is provided between the surface 24a of the circuit substrate 24 and the second metal housing 44, and is mounted so as to cover the CDR device 60b mounted on the surface 24a of the circuit substrate 24. More specifically, the circuit substrate 24 is connected to the second metal housing 44 via the first heat conducting sheet 70.

In addition, a second heat conducting sheet 72 is disposed in the accommodation space S. The second heat conducting sheet 72 is provided between a rear surface 24b of the circuit substrate 24 and the third metal housing 46. The second heat conducting sheet 72 is mounted in a portion on the other side of a region where the CDR device 60b is mounted and a region where the lens array component 65 is mounted in the surface 24a of the circuit substrate 24. More specifically, the circuit substrate 24 is connected to the third metal housing 46 via the second heat conducting sheet 72.

Next, a method of assembling the optical module 1 will be described.

First, the circuit substrate 24, integrally formed with the electrical connector 22 connected thereto, is disposed within the first metal housing 42.

Next, coated optical fibers 7 are extracted from the optical cable 3 which has passed through the first resin housing 32 and a boot, not shown in the drawing. A connector component 64 connected to the extracted coated optical fibers 7 is coupled to a lens array component 65. At this time, the connection portion 15 mounted to the optical cable 3 is fixed to a rear end portion of the first metal housing 42.

Next, as shown in FIG. 7, the first heat conducting sheet 70 is disposed so as to cover the CDR device 60b mounted on the surface 24a of the circuit substrate 24, and the second heat conducting sheet 72 is disposed so as to cover the rear surface 24b corresponding to the region where the CDR device 60b is mounted and the region where the lens array component 65 is mounted.

In this state, the second metal housing 44 is fitted into the first metal housing 42 from above, and then the third metal housing 46 is fitted into the second metal housing 44 from below.

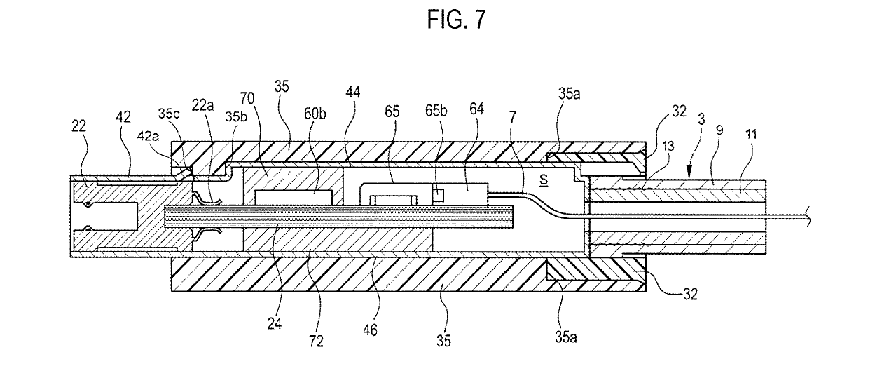

Next, the first resin housing 32 through which the optical cable 3 passes is moved to a rear end portion of the metal housing 40. As shown in FIG. 8, the engagement portions 46b provided in both the lateral sides of the third metal housing 46 engage with the opening portions 33a provided in both the lateral sides of the tube portion 33 of the first resin housing 32, respectively. Thus, the third metal housing 46 and the first resin housing 32 are fixed to each other.

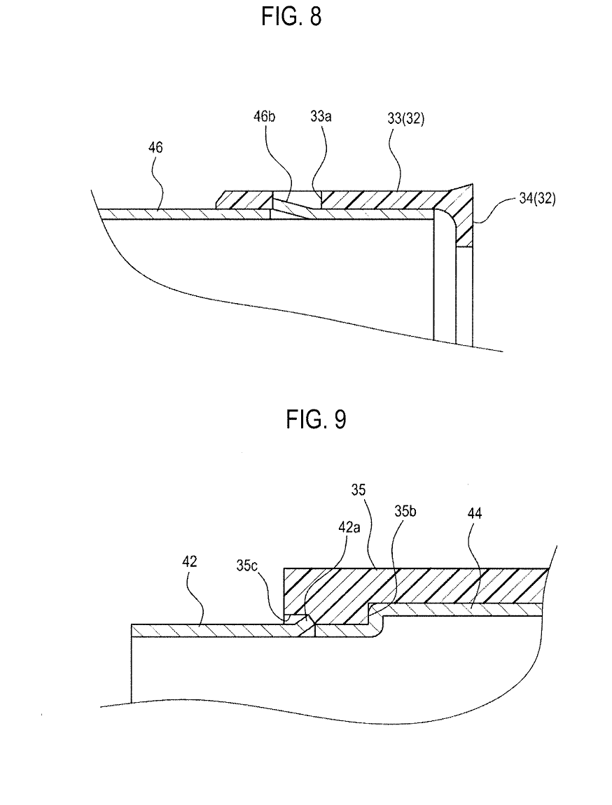

The second resin housing 35 is passed from the electrical connector 22 side, and the metal housing 40 and the first resin housing 32 are covered with the second resin housing 35. At this time, as shown in FIG. 9, the third step portion 35c provided in the inner wall surface of the second resin housing 35 engages with the engagement portion 42a provided in the upper surface of the first metal housing 42, and thus the first metal housing 42 and the second resin housing 35 are fixed to each other.

In this manner, the assembly of the optical module 1 is completed.

As shown in FIG. 8, in the assembled optical module 1, when the first resin housing 32 is moved to the optical cable 3 side which is the rear end side, the engagement between the opening portion 33a of the first resin housing 32 and the engagement portion 46b of the third metal housing 46 regulates the movement of the first resin housing 32 to the optical cable 3 side by the engagement portion 46b. That is, the entire metal housing 40 is moved to the optical cable 3 side together with the first resin housing 32 without releasing the engagement between the first resin housing 32 and the third metal housing 46.

As shown in FIG. 9, in the assembled optical module 1, when the second resin housing 35 is moved to the electrical connector 22 side, the engagement between the third step portion 35c of the second resin housing 35 and the engagement portion 42a of the first metal housing 42 regulates the movement of the second resin housing 35 to the electrical connector 22 side by the engagement portion 42a. That is, the entire metal housing 40 is moved to the electrical connector 22 side together with the second resin housing 35 without releasing the engagement between the second resin housing 35 and the first metal housing 42.

In addition, when the first resin housing 32 is moved to the electrical connector 22 side which is the front end side, the front end side of the first resin housing 32 abuts against the first step portion 35a of the second resin housing 35, and thus the second resin housing 35 and the entire metal housing 40 are moved to the electrical connector 22 side together with the first resin housing 32.

On the other hand, even when the second resin housing 35 is moved to the optical cable 3 side, the front end side of the first resin housing 32 abuts against the first step portion 35a of the second resin housing 35, and thus the entire metal housing 40 and the first resin housing 32 are moved to the electrical connector 22 side together with the second resin housing 35.

Further, when the second resin housing 35 is moved to the optical cable 3 side, the second step portion 35b provided in the second resin housing 35 abuts against the front end portion of the second metal housing 44 which is a regulation portion, and thus it is possible to regulate the movement of the second resin housing 35 to the optical cable 3 side.

In the optical module 1 having the above-described configuration, an electrical signal is input from the electrical connector 22, and the electrical signal is input to the control semiconductor 60 through a wiring of the circuit substrate 24. The electrical signal input to the control semiconductor 60 is subjected to level adjustment, waveform shaping using the CDR device 60b, and the like and is then output to the light emitting element 62a through the wiring of the circuit substrate 24 from the control semiconductor 60. The light emitting element 62a having the electrical signal input thereto converts the electrical signal into an optical signal, and emits the optical signal to the coated optical fibers 7.

In addition, the optical signal transmitted by the optical cable 3 is incident on the light receiving element 62b from the coated optical fibers 7. The light receiving element 62b converts the incident optical signal into an electrical signal and outputs the electrical signal to the control semiconductor 60 through the wiring of the circuit substrate 24. In the control semiconductor 60, the electrical signal is subjected to a predetermined process and is then output to the electrical connector 22.

In this manner, photoelectric conversion is performed within the optical module 1, and the transmission of a signal (data) can be performed smoothly.

According to the above-described optical module 1 of this embodiment, the first resin housing 32 engaging with the metal housing 40 so as to cover at least a portion of the metal housing 40 and the second resin housing 35 engaging with the metal housing 40 so as to cover at least another portion of the metal housing 40 are provided. The metal housing 40 has the engagement portion 46b engaging with the first resin housing 32 and the engagement portion 42a engaging with the second resin housing 35. According to this configuration, unlike a case where a resin is molded outside a metal housing to form a protection cover as in the related art, the metal housing 40 can engage with the first resin housing 32 and the second resin housing 35 without applying a load to the circuit substrate 24 accommodated in the metal housing 40 and the electrical connector 22. In addition, the assembly between the metal housing 40, the first resin housing 32, and the second resin housing 35 is facilitated.

In addition, the movement of the first resin housing 32 and the second resin housing 35 is regulated by the engagement portions 42a and 46b, and thus the first resin housing 32 and the second resin housing 35 can be moved in association with each other without being moved separately after the optical module 1 is assembled.

In addition, according to this embodiment, since the engagement portion 42a of the first metal housing 42 engages with the third step portion 35c provided in an inner wall surface of the first resin housing 32, it is possible to easily realize reliable engagement. Further, since an engagement hole and the like are not exposed on the outside of the first resin housing 32 or the second resin housing 35, a good appearance can be obtained.

In this embodiment, the engagement portion 46b of the third metal housing 46 engages with the opening portion 33a provided in the tube portion 33 of the first resin housing 32, and the engagement portion 42a of the first metal housing 42 engages with the third step portion 35c provided on the inner side of the second resin housing 35. In addition, the first resin housing 32 and the second resin housing 35 are fitted to each other so as to cover the tube portion 33 of the first resin housing 32 with the second resin housing 35. According to this configuration, since the opening portion 33a of the first resin housing 32 which engages with the engagement portion 46b is covered with the second resin housing 35 which is an outermost peripheral housing, a good appearance can be obtained without exposing an engagement hole and the like on the outside.

In this embodiment, the engagement portion 42a is provided in an upper surface of the first metal housing 42, while the engagement portion 46b is provided in both the lateral sides of the third metal housing 46. In this manner, it is preferable that the engagement portion 42a be provided in a surface different from a surface in which the engagement portion 46b is provided in the metal housing 40. According to this configuration, stress applied to the metal housing 40 by the first resin housing 32 and the second resin housing 35 is not concentrated on a specific surface, and thus the durability of the optical module 1 can be improved.

In this embodiment, the front end portion of the second metal housing 44 has a function as a regulation portion that regulates the movement of the second resin housing 35 to the optical cable 3 side. According to this configuration, even when the second resin housing 35 engages with the metal housing prior to the first resin housing 32, the movement of the second resin housing 35 to the optical cable 3 side can be regulated, and thus it is possible to enhance the degree of freedom of an assembly procedure.

Incidentally, if the circuit substrate 24 is connected to the metal housing through a supporting member such as a heat conducting sheet, when a resin housing is molded by resin molding as in the related art, there is a possibility of a resin, flowing from a gap in the metal housing, reaching the circuit substrate through the supporting member. On the other hand, according to this embodiment, since the first and second resin housings 32 and 35 are constituted by a resin molded product, even when the circuit substrate 24 is connected to the metal housing 40 through the first and second heat conducting sheets 70 and 72 and the like, special consideration for eliminating the gap in the metal housing 40 is not necessary.

Although the present invention has been described so far in detail with reference to a specific embodiment, it will be obvious to those skilled in the art that various changes and modifications may be made without departing from the spirit and the scope of the invention.

This application is based on a Japanese patent application filed on Nov. 6, 2012 (Japanese Patent Application No. 2012-244830), the entire contents thereof being thereby incorporated by reference. In addition, all of the references cited herein are incorporated as a whole.

### REFERENCE SIGNS LIST

1: Optical module

3: Optical cable

5: Connector module

7: Coated optical fiber

9: Jacket

11: Tensile strength fiber

13: Metal braid

20: Housing

24: Circuit substrate

30: Resin housing

32: First resin housing

33: Tube portion

33a: Opening portion

35: Second resin housing

35a: First step portion

35b: Second step portion

35c: Third step portion

40: Metal housing

42: First metal housing

44: Second metal housing

46: Third metal housing

60: Control semiconductor

62: Light receiving and emitting element

64: Connector component

65: Lens array component

70: First heat conducting sheet

72: Second heat conducting sheet

S: Accommodation space

1-6. (canceled)

7. An electronic device with cable comprising:
a circuit substrate;
an electrical component mounted on the circuit substrate;
an electrical connector connected to one end of the circuit substrate;
a cable connected to the other end of the circuit substrate;
a metal housing which accommodates the electrical connector and the circuit substrate;
a first resin housing which engages with the metal housing so as to cover at least a portion of an outer surface of the metal housing; and
a second resin housing which engages with the metal housing so as to cover at least another portion of the outer surface of the metal housing.

8. The electronic device with cable according to claim 7,
wherein the metal housing has a first engagement portion engaging with the first resin housing and a second engagement portion engaging with the second resin housing.

9. The electronic device with cable according to claim 8,
wherein movement of the first resin housing to the cable side is regulated by the first engagement portion, and movement of the second resin housing to the electrical connector side is regulated by the second engagement portion.

10. The electronic device with cable according to claim 8, wherein at least one of the first engagement portion and the second engagement portion engages with a step portion which is provided on the inner side of at least one of the first resin housing and the second resin housing.

11. The electronic device with cable according to claim 10,
wherein the first engagement portion engages with an opening portion, provided in a tube portion of the first resin housing, or the step portion.

12. The electronic device with cable according to claim 10,
wherein the second engagement portion engages with the step portion provided on the inner side of the second resin housing, or an opening portion provided on the second resin housing.

13. The electronic device with cable according to claim 10,
wherein the first engagement portion engages with an opening portion, provided in a tube portion of the first resin housing, or the step portion,
wherein the second engagement portion engages with the step portion provided on the inner side of the second resin housing, or an opening portion provided on the second resin housing, and
wherein the first resin housing and the second resin housing are fitted to each other so as to cover the opening portion provided in the one of the first resin housing and the second resin housing with the other one of the first resin housing and the second resin housing.

14. The electronic device with cable according to claim 8, wherein the second engagement portion is provided in a surface different from a surface in which the first engagement portion is provided in the metal housing.

15. The electronic device with cable according to claim 7, wherein the metal housing is provided with a regulation portion that regulates movement of the second resin housing to the cable side.

16. The electronic device with cable according to claim 7, further comprising:
a light receiving and emitting element disposed on the circuit substrate, and
wherein the cable includes an optical fiber, and
wherein the light receiving and emitting element is optically connected to the optical fiber.

17. The electronic device with cable according to claim 16, further comprising:
a lens array component disposed on the circuit substrate so as to cover the light receiving and emitting element,
wherein the lens array component has a reflection film configured to reflect and bend light emitted from the light receiving and emitting element or light emitted from the optical fiber.

18. The electronic device with cable according to claim 17, further comprising:
a connector component attached to a terminal of the optical fiber,
wherein the connector component and the lens array component are positioned using a positioning pin of the lens array component to be coupled to each other so that the optical fiber and the light receiving and emitting element are optically connected to each other.

19. The electronic device with cable according to claim 7, wherein the circuit substrate is connected to the metal housing through a supporting member with heat conduction performance.

20. The electronic device with cable according to claim 19,
wherein the electrical component includes a clock data recovery (CDR) device, and
wherein the supporting member includes a first heat conducting sheet mounted on the circuit substrate so as to cover the CDR device, and
wherein the circuit substrate is connected to the metal housing via the first heat conducting sheet.

21. The electronic device with cable according to claim 19, further comprising:
a light receiving and emitting element disposed on the circuit substrate; and
a lens array component disposed on the circuit substrate so as to cover the light receiving and emitting element,
wherein the supporting member includes a second heat conducting sheet mounted in a portion on the other side of the circuit substrate where the lens array component is mounted, and
wherein the circuit substrate is connected to the metal housing via the second heat conducting sheet.
